(19) United States
(12) Patent Application Publication
(10) Pub. No.: US 2015/0072828 A1
(43) Pub. Date: Mar. 12, 2015

(54) Planetary Gearbox Transmission using Gear Bearings

(71) Applicant: Jeffrey A Reuter, Hollis, NH (US)

(72) Inventor: Jeffrey A Reuter, Hollis, NH (US)

(21) Appl. No.: 14/024,622

(22) Filed: Sep. 11, 2013

(51) Int. Cl. F16H 1/46

(52) U.S. Cl. CPC F16H 1/46
USPC 475/337

(57) ABSTRACT

The invention uses gear bearings and planet carriers to create a planetary transmission with one or more stages. The gear bearing provides the planet gears, sun gears, and ring gear portion of each planetary stage. A planet carrier connects the planet gears of each stage to the next stage, or the output shaft. The planet carrier interfaces to the gear bearing through holes in the planetary gear elements, or posts which extend from the top of the planetary gear elements. Thus each stage can be built from as little as two parts. Each stage of the planetary transmission can be attached to another planetary transmission stage to provide multiple levels of gear reduction.

### FIELD OF THE INVENTION

The invention relates to mechanical gearboxes and transmissions, and more particularly to planetary gear transmission mechanism. The invention is also related to the application of gear bearings to create multistage planetary gear transmissions. The invention is also related to 3D printing.

### BACKGROUND ART

Planetary transmissions are specialty gear trains that offer compact gear reductions, with the output shaft spinning in the same direction as the input shaft. Planetary transmissions have historically been assembled from individual parts. The parts for each stage of a planetary transmission include a sun gears, planetary gears, a stationary outer ring, planet carriers, inter-stage drive shafts, and bearing subassemblies.

Gear bearings are a recent invention which uses a herringbone gear pattern to make it impossible for the bearing to come apart, giving it the features of a needle bearing and a thrust bearing. These gear bearings are particularly suited to fabrication with 3D printers, since the herringbone pattern of the gears make it impractical to assemble after the parts are fabricated.

Computer aided design (CAD) source code has been published for gear bearing designs on the thingiverse.com website. The CAD source code was published under a creative commons, attribution, share alike license, but no patent claims were identified. The applications discussed on this website included general rotary bearing applications such as wheels and classical bearing replacements. However, at the time of this invention, there have been no designs discussed or presented related to multistage planetary transmissions.

FIG. 1 illustrates the operation of the gear bearing. A gear bearing is made from a central “sun” gear, a circular arrangement of “planetary” gears, and an outer ring gear. The face of each gear uses a “herringbone” pattern, which angles the gear teeth in two directions. The result of the herringbone gear tooth pattern is that once assembled, the sun, planetary, and ring gears mesh in such a way as to prevent any of the gears from falling out of the assembly. This provides the gear bearing with stability under loads parallel with the axis of rotation, perpendicular to the axis of rotation, and for moment loads which try to bend the axis. This arrangement essentially creates a bearing with the attributes of an axial bearing, and a thrust bearing.

The gear bearing is well suited to manufacturing using 3D printing techniques, where layers of material are deposited incrementally. This allows the herringbone gear pattern to be built layer up on layer, trapping the planetary gears between the sun and carrier gear such that he gear bearing cannot be disassembled without destroying the part. Note that this is not the only way to manufacture a gear bearing. Designs exist where the sun bearing is fabricated in two parts, with each part having half of the herringbone pattern. The planetary and carrier gears can be assembled, and the two sun gear parts can be inserted from each side.

### DETAILED DESCRIPTION OF THE INVENTION

The invention creates a multistage planetary gear assembly out of pairings of gear bearings and adapter plates.

FIG. 2 illustrates one method of creating a planetary transmission using gear bearings.

Item 5 is the drive shaft which is driven from an external power source, such as an electric motor. Item 6 is a gear bearing which has small posts built into the each planetary gear. Item 7 is an adapter carrier plate with a pattern of matching holes mates to the posts. As the item (5) drive shaft spins the sun gear, the item (7) carrier plate spins at the rotation rate of the planetary gears, which is a slower rate, based on the gear ratio created by the arrangement of gear bearing sun, planet and carrier gears in item (6). The drive shaft portion of the item (7) carrier plate can drive the sun gear in the next item (6) gear bearing. Additional gear bearings and adapter plates may be added as needed to achieve the desired output to input gear ratio.

The carrier plate in the final gear stage can be modified with shafts or other extensions as needed to drive a desired mechanism.

The outer body of the gear bearing can be extended to attach to the next stage, or to provide mounting features for attachment to other structures.

FIG. 3 illustrates another method to connect one planetary gear stage to another. In this example, the Item (8) gear bearing has holes in each planetary gear. Item (9) is another type of carrier plate, but in this case it includes pins that insert into the planetary gear holes. Similar to FIG. 2, the adapter plate spins at a slower rate than the item (5) input shaft, and multiple stages can be built using multiple copies of the item (8) gear bearing and item (9) adapter plate.

This invention covers the use of the inter-stage carrier assemblies described in FIGS. 2 and 3, as well as other inter-stage adapter techniques and/or combination of techniques.

In the embodiments described above, a gear bearing is formed with five planetary gears. The number of planetary gears that can be used to create each planetary stage is not limited to five. Furthermore, the number of gear teeth used for the sun gear, planetary gears, and outer ring in each planetary stage may be more or less than illustrated in FIGS. 2 and 3, to achieve the desired gear reduction ratio.

### DESCRIPTION OF THE DRAWINGS

FIG. 1 is an exploded view of a gear bearing.

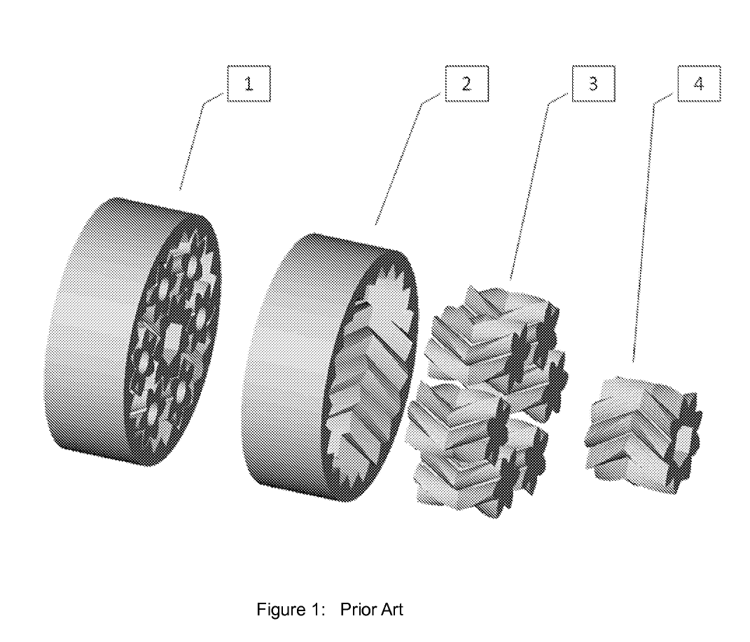

FIG. 2 is an exploded perspective view, showing how a planetary transmission may be built using gear bearings, with planetary posts and an adapter carrier plate with holes to drive the next transmission stage.

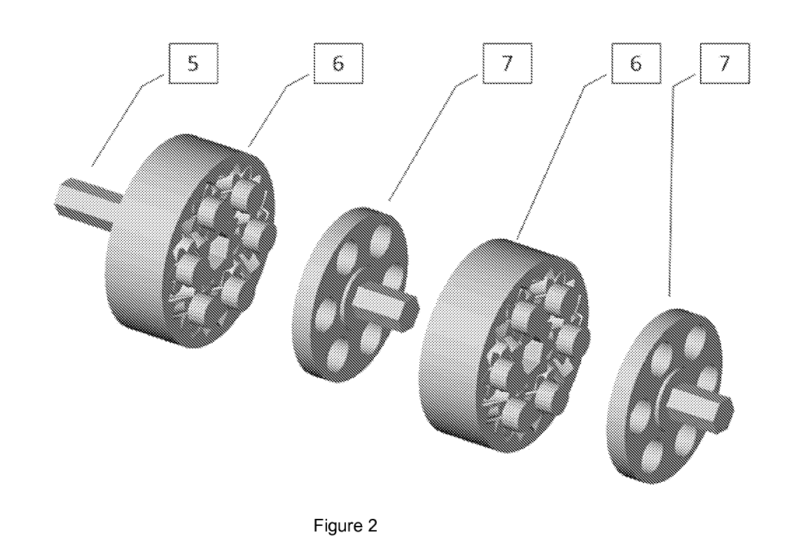

FIG. 3 is an exploded perspective view, showing how a planetary transmission may be built using gear bearings, with planetary holes and a adapter carrier pin plate to drive the next transmission stage.

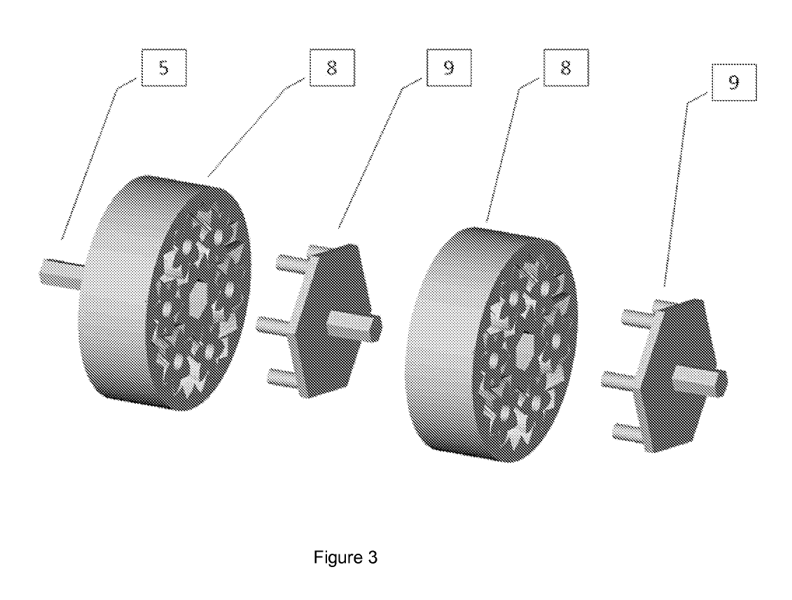

### REFERENCE NUMERALS IN THE DRAWINGS

1 Gear bearing, assembled
2 Ring gear/outer housing
3 Planetary gears
4 Sun gear
5 Input shaft
6 Gear bearing, with posts on each planetary gear
7 Carrier plate with holes
8 Gear bearing, with holes in each planetary gear
9 Carrier plate with pins

The invention claimed is:

1. A multistage planetary transmission consisting of one or more stages of a gear bearing and planet carrier, comprising:
a gear bearing consisting of herringbone gears configured with a sun gear, planet gears and an outer ring gear
intermediate planet carrier assemblies which interface to the planetary gears and drive either an output shaft or the sun gear of the next gear stage

2. A multi stage planetary transmission as recited in claim 1 which is comprised of one or more pairs of gear bearings and adapter plates.

3. A multistage planetary transmission as recited in claim 1 which uses inter-stage planet carrier assemblies, including a post and hole assembly, a hole and pin assembly, and other methods of connecting the rotary motion of the planet gears to the sun gear of the next stage

4. A multistage planetary transmission as recited in claim 1 where the outer carrier gear of the gear bearing has added features to connect the gear bearing to the gear bearing of the next stage

5. A multistage planetary transmission as recited in claim 1 where the outer carrier gear of the gear bearing has added features for mounting the multistage planetary transmission to another structure
